(19) United States
(12) Patent Application Publication
(10) Pub. No.: US 2022/0004630 A1
(43) Pub. Date: Jan. 6, 2022

(54) SYSTEMS AND METHODS FOR A MULTI-MODEL APPROACH TO PREDICTING THE DEVELOPMENT OF CYBER THREATS TO TECHNOLOGY PRODUCTS

(71) Applicant: Cyber Reconaissance, Inc., Tempe, AZ (US)

(72) Inventors: Mohammed Almukaynizi, Riyadh (SA); Paulo Shakarian, Chandler, AZ (US); Jana Shakarian, Chandler, AZ (US); Malay Shah, Tempe, AZ (US)

(21) Appl. No.: 17/357,597

(22) Filed: Jun. 24, 2021

Related U.S. Application Data
(60) Provisional application No. 63/047,094, filed on Jul. 1, 2020.

(51) Int. Cl. G06F 21/55; G06F 21/57; G06N 20/20; G06F 40/44; G06F 40/56

(52) U.S. Cl. CPC G06F 21/554; G06F 21/57; G06F 40/56; G06F 40/44; G06N 20/20

(57) ABSTRACT

Systems may anticipate exploitation of cyber threats to various technologies. The systems may receive threat-intelligence data from a threat intelligence source, extracting a technology identified in the threat-intelligence data, and extract a first tactic from the threat-intelligence data wherein the tactic is associated with the technology. The system may receive ground-truth data from a ground-truth data source and extract a second technology identified in the ground-truth data. The first technology may match the second technology. The system may extract a second tactic from the ground-truth data wherein the tactic is associated with the technology with the first tactic matching the second tactic. The system may train a statistical model to predict threats to at least one of the first technology or the second technology.

### CROSS REFERENCE TO RELATED APPLICATION

The present application claims priority to and the benefit of U.S. provisional patent application No. 63/047,094 filed on Jul. 1, 2020, which is incorporated by reference in its entirety for any purpose.

### FIELD

The present disclosure generally relates to predicting development of cyber threats, and in particular to systems and methods for applying models to predict development of cyber threats and proactively enhance cyber defenses.

### BACKGROUND

Cybersecurity teams may become aware of vulnerable systems within their organizations yet fail to promptly mitigate cyber risks. A key reason for this is the lack of resources and the high cost of timely deploying security countermeasures. For example, some computing systems are taken offline to deploy countermeasures and then brought back online, a process that may have undesirable impacts on day-to-day operations. Furthermore, the heavy reliance on detection-based cyber defense technologies, which detect risks after they are present in the defender's environment, may not help in prioritizing cyber risk mitigation. Attacks are only detected after they leave behind significant damage to the target computing system in many cases. It is difficult to proactively identify threats likely to be exploited by threat actors.

### SUMMARY

Systems, methods, and devices (collectively, the “System”) of the present disclosure may anticipate exploitation of cyber threats to various technologies, in accordance with various embodiments. The systems may receive threat-intelligence data from a threat intelligence source, extracting a technology identified in the threat-intelligence data, and extract a first tactic from the threat-intelligence data wherein the tactic is associated with the technology. The system may receive ground-truth data from a ground-truth data source and extract a second technology identified in the ground-truth data. The first technology may match the second technology. The system may extract a second tactic from the ground-truth data wherein the tactic is associated with the technology with the first tactic matching the second tactic. The system may train a statistical model to predict threats to at least one of the first technology or the second technology.

In various embodiments, the System may select a model by matching metadata associated with a model and at least one of the first technology, the first tactic, the second technology, or the second tactic. The model may include a multiple-model ensemble. The system may further retrain a statistical model in response to a metric exceeding or equaling a threshold value. The statistical model may further separate threat-intelligence data and ground-truth data into a plurality of partitions and assign each partition from the plurality of partitions to a system-level resource.

In various embodiments, the System may extract the first tactic from the threat-intelligence data by applying natural language processing and regular expressions to the threat- intelligence data. The System may apply natural language processing and regular expressions to the threat-intelligence data. The first technology, the first tactic, the second technology, the second tactic, the ground-truth data, and the threat-intelligence data may be cleaned and normalized. The system may extract features from the first technology, the first tactic, the second technology, the second tactic, the ground-truth data, and the threat-intelligence data to generate at least one of a data type or a data structure.

In various embodiments, the System may receive a threat intelligence feed from the threat intelligence source, extract metadata from the threat intelligence feed, and match metadata from the threat intelligence source to a statistical model. The system may predict a likelihood of a compromise to the first technology using the statistical model. The system may calculate a performance metric for the statistical model comprising, for example, precision, recall, false positive rate, or true positive rate. The System may further retrain the statistical model in response to the performance metric exceeding a threshold value. The threat-intelligence data and the ground-truth data split into a plurality of partitions. The System may assign the partition to a system level process to train the statistical models to predict threats to the first technology or the second technology.

### BRIEF DESCRIPTION

The subject matter of the present disclosure is particularly pointed out and distinctly claimed in the concluding portion of the specification. A more complete understanding of the present disclosure, however, may best be obtained by referring to the detailed description and claims when considered in connection with the illustrations.

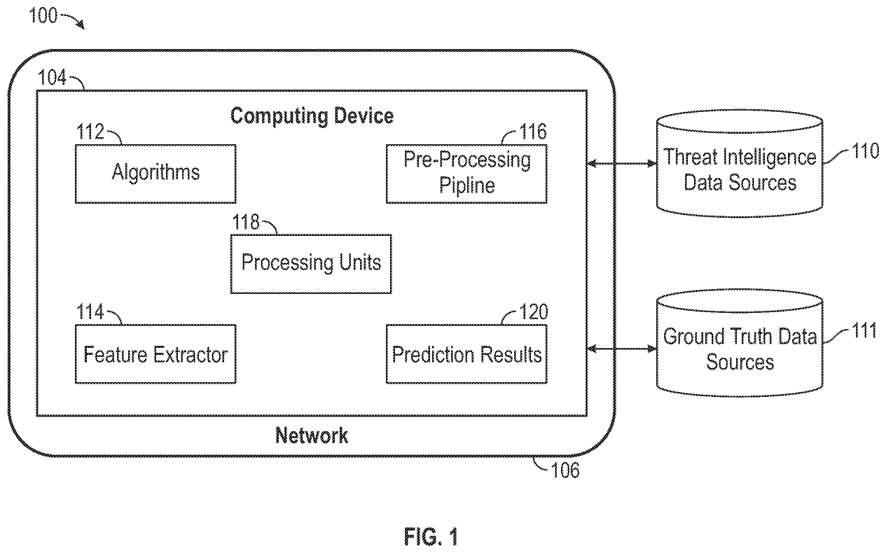

FIG. 1 illustrates a system for predicting threats for various technologies and vulnerabilities, in accordance with various embodiments;

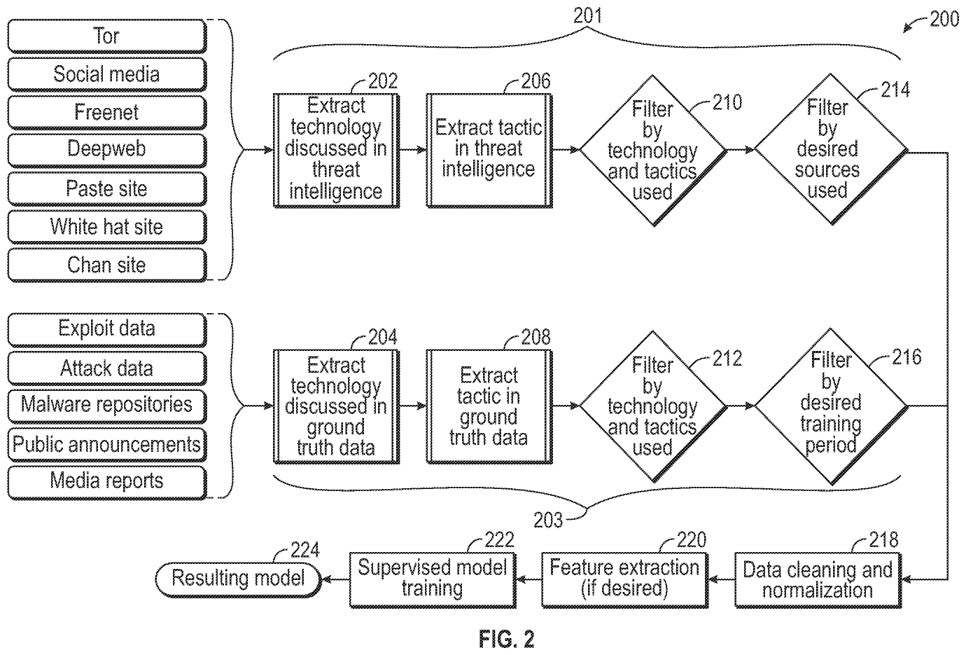

FIG. 2 illustrates a process for training machine learning models for predicting threats for various technologies and vulnerabilities, in accordance with various embodiments;

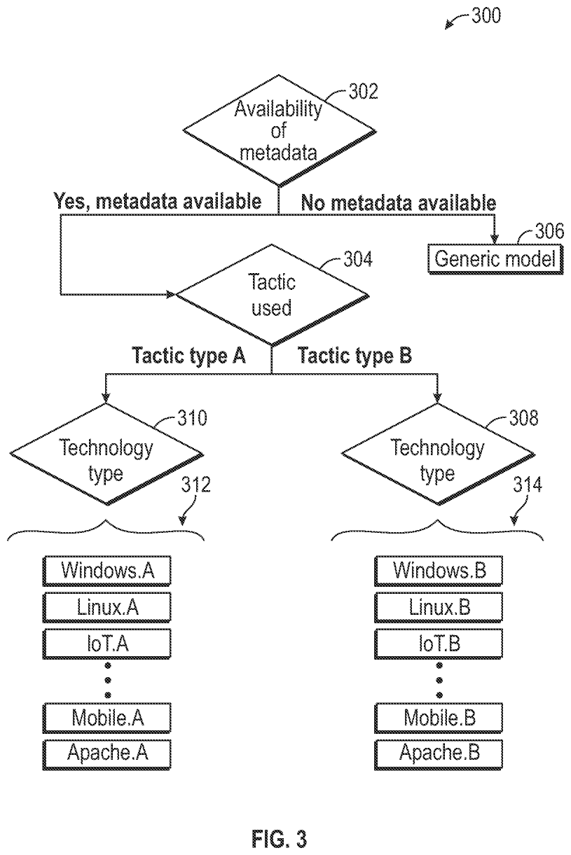

FIG. 3 illustrates a process for training specialized machine learning models for predicting threats for various technologies and vulnerabilities, in accordance with various embodiments;

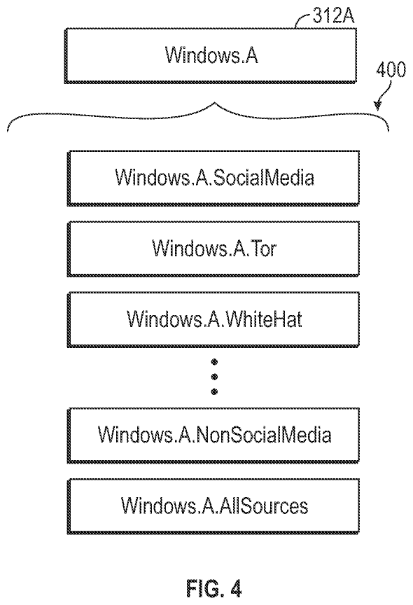

FIG. 4 illustrates a multi-ensemble infrastructure with an individual model having multiple models, in accordance with various embodiments;

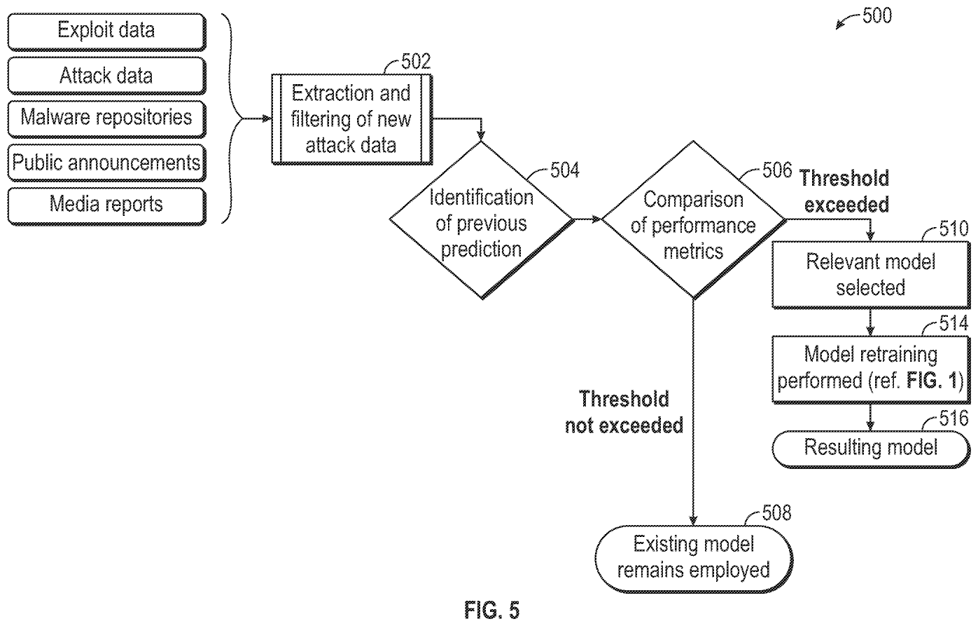

FIG. 5 illustrates a process for dynamically retraining models for predicting threats for various technologies and vulnerabilities, in accordance with various embodiments; and

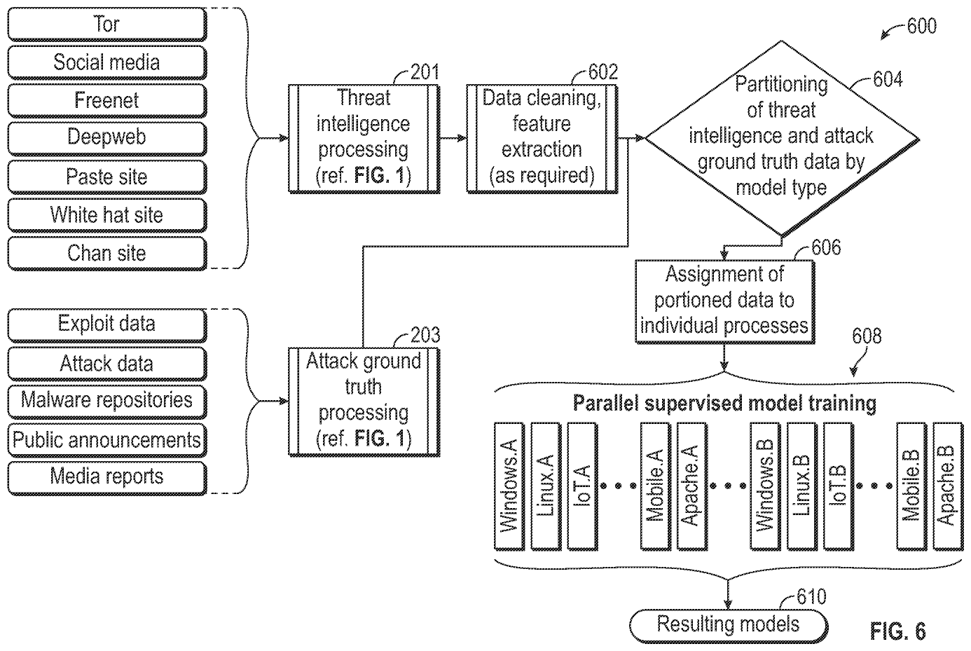

FIG. 6 illustrates a process for retraining models for predicting threats for various technologies and vulnerabilities using parallel processing infrastructure, in accordance with various embodiments.

### DETAILED DESCRIPTION

The detailed description of exemplary embodiments herein refers to the accompanying drawings, which show exemplary embodiments by way of illustration and their best mode. While these exemplary embodiments are described in sufficient detail to enable those skilled in the art to practice the inventions, it should be understood that other embodiments may be realized, and that logical and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Aspects of the present disclosure relate to embodiments of computer-implemented systems and methods for developing, selecting, and using machine-learning-based multi-models that predict the emergence of cyber threats by leveraging data from various cyber threat intelligence sources. Various embodiments may interact with a database of threat intelligence. The database of threat intelligence may comprise data (text and other metadata) collected from variety of sources and tagged by the original source type such as, for example, TOR, social media, freenet, deepweb, paste sites, chan sites, or other suitable original source types. The database of threat intelligence may also comprise a database of attacks ground-truth data that includes attack data collected from a variety of sources and tagged by the original source type, such as exploit archives, attack databases, malware repositories, media reports, public announcements, or other suitable sources. This data may be obtained from an external system such as CYR3CON® API.

As used herein, the term “Common Vulnerabilities and Exposures” (CVE) refers to a unique identifier assigned to each software vulnerability reported in the National Vulnerability Database (NVD) as described at https://nvd.nist.gov (last visited Jun. 16, 2020). The NVD is a reference vulnerability database maintained by the National Institute of Standards and Technology (NIST). The CVE numbering system typically follows a numbering formats such as, for example, CVE-YYYY-NNNN or CVE-YYYY-NNNNNNN where the “YYYY” indicates the year in which the software flaw is reported, and the N′s is an integer identifying a flaw. For example, CVE-2018-4917 identifies an Adobe® Acrobat flaw and CVE-2019-9896 identifies a PuTTY flaw.

As used herein, the term “Common Platform Enumeration” (CPE) refers to a list of software/hardware products that are vulnerable to a given CVE. The CVE and the respective platforms affected (i.e., CPE data) can be obtained from the NVD. For example, the following CPE's are some of the CPE's vulnerable to CVE-2018-4917:

cpe:2.3:a:adobe:acrobat_2017:*:*:*:*:*:*:*:*

cpe:2.3:a:adobe:acrobat_reader_dc:15.006.30033:*:*:*:classic:*:*:*

cpe:2.3:a:adobe:acrobat_reader_dc:15.006.30060:*:*:*:classic:*:*:*

Systems, methods, and devices (collectively, the “System”) of the present disclosure systematically address these challenges by modeling the correlation between cyberthreat-intelligence data and real-world attack patterns, in accordance with various embodiments. Threat intelligence data feeds may differ significantly based on the source of threat intelligence, the attack tactics extracted from the feeds, and the type of technology extracted from the feeds. Some technologies are at more risk to certain attack tactics than others. For example, software products that are written in C and C++ are at significantly greater risk to buffer overflow attacks (a common attack vector) than software products written in other languages. Systems of the present disclosure may thus select models for predictive use based at least in part on technology type.

In various embodiments, the nature of hacking discussions and the attack patterns may change rapidly as technology advances. New vulnerabilities are discovered, and new patches are released by software vendors regularly. Systems of the present disclosure may systematically identify whether the currently in-use model should be updated to model the changes in the underlying distribution of threat-intelligence data and attack patterns.

In various embodiments and for multi-model machine learning applications, frequent updates to models (i.e., retraining models) may consume considerable time and computing resources. Systems of the present disclosure may partition data for more efficient processing. Computing tasks may be assigned to processing units in a parallel fashion for multiprocessing computing systems. Parallel processing may improve efficiency compared to sequential processing in response to operating on suitable computing hardware.

Referring now to FIG. 1, system 100 is shown for training machine learning driven models to predict threats to various technologies related to associated vulnerabilities, in accordance with various embodiments. The system 100 shows a computing and networking environment suitable for implementing aspects of the present disclosure. In general, the system 100 includes at least one computing device 104, which may be a server, controller, a personal computer, a terminal, a workstation, a portable computer, a mobile device, a tablet, a mainframe, or other suitable computing device. System 100 may include a plurality of computing devices connected through a computer network 106, which may include the Internet, an intranet, a virtual private network (VPN), and the like. A cloud (not shown) hardware and/or software system may be implemented to execute one or more components of the system 100.

In various embodiments, computing device 104 may comprise computing hardware capable of executing software instructions through at least one processing unit 118. Moreover, the computing device and the processing unit may access information from one or more data sources supporting threat-intelligence data (110) and ground-truth data of real-world attack patterns (111). The computing device may further implement functionality associated predicting threats to various technologies related to associated vulnerabilities defined by various modules; namely, an algorithms module 112, a feature extractor module 114, a pre-processing pipeline module 116, and a prediction results module 120.

In various embodiments, algorithm module 112 may comprise one or more algorithms executable on one or more processing units 118 to train machine learning (ML) models, build pre-processing pipeline 116, and/or build feature extractor 114. Pre-processing pipeline 116 may be a module, may be configurable by the user, and may use algorithms from algorithm module 112 containing executable code to perform steps of the processes described below. Computing device 104 may read or otherwise retrieve data from threat-intelligence data sources 110 and/or ground-truth data sources 111. Computing device 104 may also execute pre-processing pipeline 116 using algorithm module 112. The output may include processed data in the form of a data structure in stored memory (e.g., RAM) and writable to a storage device (e.g., a hard drive, solid-state drive, or storage array).

In various embodiments, feature extractor module 114 may comprise a sequence of instructions executable by processing units 118 to extract features from data structures. Data structures for extraction by extractor module 114 may be generated by pre-processing pipeline 116 to produce feature vectors, for example. Prediction results 120 may comprise a module that stores the prediction results of the ML models (e.g., the output of Systems described herein). The input to the ML models may be feature vectors.

Referring now to FIG. 2, framework or process 200 shown for training machine learning driven models to predict threats to a given piece of technology and associated vulnerabilities is shown, in accordance with various embodiments. Process 200 may use specialized models determined by software category and attack type. Process 200 may be leveraged to train specialized machine learning models that may be used to predict cyber threats based on specific threat intelligence and attack ground truth sources according to the various embodiments. Process 200 may select models for training variously based on data source, technology, and/or vulnerability, though process 200 may selectively omit one or more step in various embodiments based on, for example, desired use of the models and availability of sufficient data to apply steps.

In various embodiments, process 200 may comprise a method for training specialized machine learning models determined by the source of threat intelligence. Process 200 may execute various steps to train machine learning models on a desired subset of threat intelligence sources. Process 200 may comprise threat-intelligence data processing Steps 201 and ground-truth data processing Steps 203.

In various embodiments, process 200 may include extracting technology discussed in the threat-intelligence data (Step 202) from various sources such as, for example, TOR, social media, freenet, deepweb, paste sites, chan sites, or other suitable original source types. The threat-intelligence data may include text content that may discuss certain technology types. Different techniques may be used to identify the discussed technology from the text if present in various embodiments. System 100 may extract the technology using natural language processing (NLP) techniques to identify software names or using regular expressions to identify software discussed. NLP techniques may include, for example, using Word2vec or other neural network techniques to find words from hacker discussions that are similar to software names. Regular expressions may also identify patterns in text such as, for example, names and/or versions of software products.

System 100 may also extract the technology starting with identification of the vulnerability used against software and re-aligning with the software name through a vulnerability database lookup. For example, assuming a vulnerability is discussed in a hacker forum by referencing its CVE identification, system 100 may run a database query using the CVE to identify software products are affected by that CVE and annotate the discussion with those products. System 100 may also extract the technology referenced in threat-intelligence data by further aligning technology names with frameworks such as the NIST CPE numbering system. For example, assuming system 100 has identified a certain discussion is about a vulnerability affecting an operating system and it affects Microsoft® Windows® (version X) and Microsoft® Windows Server® (version Y), system 100 may limit the search space by querying the CPE database for CPEs that affect operating systems Microsoft® Windows® (version X) and Microsoft® Windows Server® (version Y). System 100 may also use other suitable techniques to identify technology.

In various embodiments, system 100 executing process 200 may extract technology discussed in the ground-truth data (Step 204). The ground-truth data may include text content that discusses or otherwise references certain technology types. System 100 may use similar techniques to extract technology discussed in ground-truth data to those discussed in reference to Step 202 above. Various techniques may be used to identify the discussed technology from the text if present in various embodiments. For example, system 100 may extract the technology using NLP techniques to identify software names or using regular expressions to identify software discussed in ground-truth data. System 100 may also extract the technology discussed in ground-truth data using identification of the vulnerability used against software and re-aligning with the software name through a vulnerability database lookup. Extracting the technology referenced in ground-truth data may also be done by further aligning technology names with frameworks such as the NIST CPE numbering system. Ground truth data also be stored in structured data formats and may be queried or retrieved from database tables. Ground truth data may be annotated with software names (i.e., technology used), version numbers, or other identifying information to aid in extracting technology type.

In various embodiments, system 100 may extract an attack tactic from threat-intelligence data (Step 206). The threat-intelligence data may reference some indictors of certain attack tactics (or attack vectors) such as SQL injections (SQLI) and cross-site scripting (XSS). Identifying the tactics may help identify the corresponding vulnerabilities and/or vulnerable system and product. Various techniques may be used to identify the discussed tactics from the text of threat-intelligence data if present such as, for example, using NLP techniques to identify hacking tactic (e.g., SQLI, XSS, RCE, etc.) or using regular expressions to identify tactic discussed. In another example, system 100 may identify the vulnerability used against software and re-align with the hacker tactic through vulnerability database lookup. In various embodiments, the computer-based system may align tactics with frameworks such as MITRE ATT&CK or the NIST CWE numbering system to identify tactics.

In various embodiments, system 100 may extract a tactic from ground-truth data (Step 208). System 100 may use similar techniques to those discussed in reference to Steps 202 and 204 above to extract a tactic discussed in ground-truth data. Ground truth data may provide information about attack tactics or attack vectors such as, for example, SQL injections (SQLI) and cross-site scripting (XSS). Various techniques may be used to identify the discussed tactics from the text of ground-truth data. For example, using NLP techniques to identify hacking tactic (e.g., SQLI, XSS, RCE, etc.) or using regular expressions to identify tactic discussed. In another example, system 100 may identify the vulnerability used against software and re-align with the hacker tactic through vulnerability database lookup. In various embodiments, the computer-based system may align tactics with frameworks such as MITRE ATT&CK or the NIST CWE numbering system to identify tactics.

In various embodiments, system 100 may filter data extracted from threat-intelligence data in Steps 202 and 206 by the technology and tactics used (Step 210) and/or the data sources from which the data originated (Step 214). System 100 may filter data extracted from ground-truth data in Steps 204 and 208 by the technology and tactics used (Step 212) and/or the desired period from which the data originated for use in training models (Step 216).

In various embodiments, system 100 may apply data cleaning and normalization to the filtered data from Steps 214 and 216 (Step 218). Data cleaning may include removing some parts of the data. For example, data cleaning may include removing stop words such as “is,” “in,” “and,” “etc.” Normalization may include changing numeric values to a common scale such as [0, 1].

In various embodiments, system 100 may extract and select features (Step 220). Feature extraction is a machine learning practice for transforming data into data types and data structures that can be used by machine learning algorithms. Feature selection may result in performance enhancement in terms of prediction accuracy. Stated another way, feature selection may increase the number of correct predictions (true positives), decrease the number incorrect predictions (false positives), and/or decrease processing time. Selected features may be a small subset of all features and processing a smaller amount of data may be desired for optimal use of computing resources.

In various embodiments, system 100 may train machine learning models (Step 222). Training machine learning models may include executing machine learning algorithms on the extracted and selected features to produce models. There may be various possible configurations on machine learning algorithms suitable to fit models to data. Examples of machine learning algorithms include Random Forest (ensemble approach), Support Vector Machines, and Logistic Regression. Systems and methods of the present disclosure may further be leveraged to execute machine learning algorithms usable without a training step. This class of algorithms is often classified under the non-parametric machine learning, for example, K-Nearest Neighbor.

In various embodiments, system 100 may apply the Steps 201, 218, 220, and 222 to produce a plurality of specialized machine learning models (Step 224) based on the concept extraction techniques used in Steps 202, 204, 206, and 208, and based on filtering criteria used in Steps 210, 212, 214, and 216. An incoming threat intelligence feed may trigger a plurality of the resulting models, determined by the source of the threat intelligence and/or the extracted technology, which may be used to predict threats to the identified technology. A generic model may be used in response to no specialized model being identified, although use of specialized models may result in more accurate predictions.

In various embodiments, system 100 may be configured to produce machine learning models that predict threats to a given piece of technology and/or associated vulnerabilities. For example, process 200 may comprise a method for training specialized machine learning models determined by a given piece of technology and associated vulnerabilities.

System 100 executing process 200 may be configured to produce machine learning models that are both specialized for certain subset of threat intelligence sources and predict threats to a given piece of technology and associated vulnerabilities.

In various embodiments, system 100 may execute process 200 to train specialized machine learning models for certain subsets of threat intelligence sources selected based on a given piece of technology and associated vulnerabilities. System 100 may use process 200 for training specialized machine learning models based on other categories of threat intelligence such as, for example, models for threat-intelligence data of certain group of hackers. Hackers may be grouped based on their identified level of expertise, language used, country of origin, social network structure (e.g., using community finding algorithms), or other characteristics.

In another example, models based on other threat intelligence categories may include models for groupings of technology types, such as web development technology. Web development technology may include includes PHP, .NET, HTML and other common web-programming languages. In another example, models based on other threat intelligence categories may include models for common series of attack stages (this may leverage MITRE ATT&CK framework). In still another example, models based on other threat intelligence categories may include models for any mix of the categorizations.

Referring now to FIG. 3 with continuing reference to FIG. 1, a process 300 for predicting cyber threats to a given technologies and associated vulnerabilities is shown, in accordance with various embodiments. Process 300 may be a model selection process. The developed models may be used for predicting the likelihood that a given cyber threat for a given technology will occur. The present system provides a framework for selecting which models to use to produce such predictions. The system may use metadata related to the source of threat intelligence and the types of technology extracted. The system aligns this metadata with the metadata of the models developed in the multi-model approach of System 1.

In various embodiments, system 100 may execute one or more of the steps to identify metadata such as, for example, extract the technology discussed in the threat-intelligence data feeds, extract tactic in threat intelligence, and/or identify the source of threat intelligence (Step 302).

In various embodiments, system 100 may choose to use a generic model trained for all data sources and all types of attack tactics. System 100 may align this metadata with the metadata of the models produced in a multi-model approach. For example, assuming a threat intelligence feed is identified as discussing a Microsoft Windows vulnerability (CVE-2020-0601), system 100 may find model 312 for Windows.A, developed using techniques described herein, that is specialized for Windows-related threats. The system may run the threat intelligence feed on the model Windows.A to make a prediction.

In various embodiments, system 100 may be configured to select which models to use by aligning threat intelligence metadata with models' metadata using process 300. System 100 may use logic to match the metadata to a model (Step 304). For example, if tactics, technology, and/or threat intelligence source identified match the metadata of an existing model, use matching model. System 100 may use the generic model (Step 306) as a default, for example, if system 100 does not identify a matching model. System 100 may quantify the similarity between threat intelligence metadata with models' metadata and selecting the most similar models, e.g., vector-based similarity/distance measurements such as cosine similarity or other suitable similarity assessment techniques.

In various embodiments, system 100 may use dimensional analysis to select models based on matching. Metadata may be assessed categorically (i.e., either match or don't match). Model selection may be based on exact match, or best performing models (tested on a testing dataset), or closest match. Metadata may be represented in vectors with various dimensions. For example, technology itself may be represented in 3 dimensions: 1) operating system vs application vs hardware, 2) mobile vs computer vs IoT, and 3) product name. Categorical data may be represented numerically. For example, a score quantifying the skill level of individuals contributing to a given threat intelligence source. Although two technology types are depicted in FIG. 3 for clarity, system 100 may operate with several technology types selected using process 300.

For example, if system 100 identified from discussions of tactic type A: SQL injection from an incoming threat-intelligence data feed, and the system 100 is configured to use the tactics to filter data and ultimately train the multi-model approach, then system 100 would select models specialized for SQL injection vulnerabilities. System 100 would proceed to Step 310 instead of Step 308 based on identifying a type A tactic. In Step 310, the system would decide which models to use based on the technology. Continuing the example, if the vulnerability affects mobile browsers and Apache Web servers then system 100 may choose to use both model 312 and model 314 then take the average vote as a prediction. System 100 may also or alternatively compare testing results for models and select the model that produced more accurate performance results on a testing dataset.

Referring now to FIG. 4 with continued reference to FIG. 1, a multi-model ensemble process 400 is shown for predicting cyber threats to a given technology, in accordance with various embodiments. System 100 may develop a model of the multi-model approach using ensemble methods to obtain better classification performance. For example, system 100 may use two or more statistical models 400 with each providing a vote for a given test case, and system 100 may tabulate the votes to generate a prediction. System 100 may thus be configured to select which models 400 of the ensemble models 312 such as model 312A to use for making a prediction.

Continuing the example where the model Windows.A is an ensemble model that has a number of statistical models that may predict cyber threats related to Windows operating systems. Each of these statistical models of the ensemble model Windows.A may be trained on different data that is limited by the sources of threat intelligence, and some models may use multiple sources of threat intelligence. In this example, Windows.A.SocialMedia would be trained using only social media sourced threat intelligence, Windows.A.NonSocialMedia would use all sources but social media, and Windows.A.AllSource would use all available sources.

In various embodiments, the selection of which models to use when running a test case on model Windows.A may be determined in various ways. For example, system 100 may select models using best performing models (based on model training or dynamic retraining), using an aggregate (min, max, average, majority vote, etc.), and/or using hard coded logic based on data availability. The individual models may be used not only for predictions but also as metadata supplied back to the user to give transparency in the prediction.

Referring now to FIG. 5, process 500 for dynamic model retraining to predict cyber threats to a given technology and associated vulnerabilities is shown, in accordance with various embodiments. Cyber threats and threat-intelligence data may change in nature very rapidly due to the rapid change in the software industry such as, for example, new development technologies, advancing processing models, increased volume of data, and emerging development architectures. Changes may result in new attack vectors, new flaws, and developed hacking payloads. Machine learning models that predict cyber threats need to be adaptive to such rapid change in the underlying distribution of both the attack data and the threat-intelligence data. System 100 may provide such capability by dynamically re-training the models of the multi-model approach.

In various embodiments, system 100 may be configured to extract and filter new attack data (Step 502). System 100 may extract and filter attack data given a dataset of multi-sourced ground truth attack data that is actively collecting data in a manner similar to Steps 202-220 of process 200. System 100 may identify previous predictions (Step 504) by comparing new attack information with the previous prediction for the same technology and/or vulnerability. System 100 may compare performance metrics (Step 506) such as, for example, precision, recall, true positive rate, and/or false positive rate. System 100 may determine a model should not be retrained in response to a threshold condition not being met (Step 508). System 100 may determine whether a model should be retrained based on, for example, a threshold established during model training (Step 510). In response to a threshold being exceeded, e.g., false positive rate exceeds certain value, system 100 may retrain models using process 200 (Step 514). As a result, system 100 may be trained with the resulting model (Step 516).

For example, assume all models are trained on data from January 2017-December 2019. Threat intelligence data from January 2020-June 2020 may be tested using the models and be validated against the ground-truth data from the same period. Resulting metrics may be computed to assess effectiveness of the models such as false positive rate (FPR). If FPR exceeds 0.20 from some models (a threshold set by the user), system 100 may trigger the retraining framework and reproduce the set of models to be retrained on the new period.

Referring now to FIG. 6, process 600 for model retraining using parallel infrastructure to predict cyber threats to a given technology and associated vulnerabilities is shown, in accordance with various embodiments. System 100 may train individual models in parallel on suitable hardware such as, for example, multi-core processors. Threat intelligence and attack ground-truth data may be partitioned by model type. Each partitioned data may be assigned a process in the multi-processing environment.

In various embodiments, system 100 may partition threat intelligence and attack ground-truth data by model type using outputs from threat-intelligence data processing Steps 201 and/or ground-truth data processing Steps 203 of process 200 (in FIG. 2). System 100 may clean and/or extract features (Step 602) in a manner similar to Step 218 and/or Step 220 of process 200 (in FIG. 2). System 100 may partition threat intelligence and ground-truth data by model type (Step 604). System 100 may assign each piece of partitioned data (i.e., threat intelligence and the corresponding attack ground-truth data) to an individual system level process (Step 606) to perform Step 218, Step 220, and/or Step 222 of process 200 (all of FIG. 2) in a parallel. System 100 may thus perform supervised model training for multiple models using parallel processes (Step 608). For example, system 100 may train model 312 and model 314 (of FIG. 3) in parallel. System 100 may thus be trained with the resulting models (Step 610).

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Devices, systems, and methods are provided herein. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or device that comprises a list of elements does not include only those elements but may include other elements not expressly listed or inherent to such process, method, article, or device.

What is claimed is:

1. A method for anticipating exploitation of cyber threats to technologies comprising:
receiving, by a computer-based system, threat-intelligence data from a first threat intelligence source;
extracting, by the computer-based system, a first technology identified in the threat-intelligence data;
extracting, by the computer-based system, a first tactic from the threat-intelligence data wherein the first tactic is associated with the first technology;
receiving, by the computer-based system, ground-truth data from a ground-truth data source;
extracting, by the computer-based system, a second technology identified in the ground-truth data, wherein the second technology matches the first technology;
extracting, by the computer-based system, a second tactic from the ground-truth data wherein the second tactic is associated with the second technology, wherein the first tactic matches the second tactic; and
training, by the computer-based system, a plurality of statistical models to predict threats to at least one of the first technology or the second technology.

2. The method of claim 1, wherein training a statistical model further comprises matching, by the computer-based system, metadata associated with the statistical model and at least one of the first technology, the first tactic, the second technology, or the second tactic.

3. The method of claim 2, wherein the statistical model comprises a multiple-model ensemble.

4. The method of claim 1, wherein training the statistical model further comprises:
separating, by the computer-based system, threat-intelligence data and ground-truth data into a plurality of partitions; and
assigning, by the computer-based system, each partition from the plurality of partitions to a system-level resource.

5. The method of claim 1, wherein extracting the first tactic from the threat-intelligence data further comprises applying, by the computer-based system, at least one of natural language processing and regular expressions to the threat-intelligence data.

6. The method of claim 1, wherein extracting the first tactic from the threat-intelligence data further comprises applying, by the computer-based system, at least one of natural language processing and regular expressions to the ground-truth data.

7. The method of claim 1, further comprising cleaning and normalizing, by the computer-based system, at least one of the first technology, the first tactic, the second technology, the second tactic, the ground-truth data, and the threat-intelligence data.

8. The method of claim 1, further comprising extracting, by the computer-based system, features from at least one of the first technology, the first tactic, the second technology, the second tactic, the ground-truth data, and the threat-intelligence data to generate at least one of a data type or a data structure.

9. The method of claim 1, further comprising:
receiving, by the computer-based system, a threat intelligence feed from the threat intelligence source;
extracting, by the computer-based system, metadata from the threat intelligence feed; and
matching, by the computer-based system, metadata from the threat intelligence source to a statistical model from the plurality of statistical models.

10. The method of claim 1, further comprising predicting, by the computer-based system, a likelihood of a compromise to the first technology using the statistical model.

11. The method of claim 1, further comprising:
calculating, by the computer-based system, a performance metric for the statistical model, wherein the performance metric comprises at least one of precision, recall, false positive rate, or true positive rate; and
retraining, by the computer-based system, the statistical model in response to the performance metric exceeding a threshold value.

12. The method of claim 1, further comprising:
partitioning, by the computer-based system, at least one of the threat-intelligence data and the ground-truth data into a plurality of partitions;
assigning a partition from the plurality of partitions to a system level process to train the plurality of statistical models to predict threats to at least one of the first technology or the second technology.

13. A method comprising:
receiving threat-intelligence data from a first threat intelligence source;
extracting a first technology identified in the threat-intelligence data;
extracting a first tactic from the threat-intelligence data and associating the first tactic with the first technology;
receiving ground-truth data from a ground-truth data source;
extracting a second technology identified in the ground-truth data;
extracting a second tactic from the ground-truth data and associating the second tactic with the second technology; and
training a statistical model to predict threats to the first technology based on at least one of the first tactic and the second tactic in response to the first technology matching the second technology.

14. The method of claim 13, retraining the statistical model in response to a metric exceeding or equaling a threshold value.

15. The method of claim 13, wherein training the statistical model further comprises:
separating threat-intelligence data and ground-truth data into a plurality of partitions; and
assigning each partition from the plurality of partitions to a system-level resource.

16. The method of claim 13, wherein extracting the first tactic from the threat-intelligence data further comprises applying at least one of natural language processing and regular expressions to the threat-intelligence data.

17. The method of claim 16, wherein extracting the first tactic from the threat-intelligence data further comprises applying at least one of natural language processing and regular expressions to the threat-intelligence data.

18. The method of claim 17, further comprising cleaning and normalizing at least one of the first technology, the first tactic, the second technology, the second tactic, the ground-truth data, and the threat-intelligence data.

19. The method of claim 18, further comprising predicting a likelihood of a compromise to the first technology using the statistical model.

20. A computer-based system for anticipating exploitation of cyber threats to technologies comprising:
a processor; and
a tangible, non-transitory memory configured to communicate with the processor, the tangible, non-transitory memory having instructions stored thereon that, in response to execution by the processor, cause the computer-based system to perform operations comprising:
receiving threat-intelligence data from a first threat intelligence source;
extracting a first technology identified in the threat-intelligence data;
extracting a first tactic from the threat-intelligence data and associating the first tactic with the first technology;
receiving ground-truth data from a ground-truth data source;
extracting a second technology identified in the ground-truth data;
extracting a second tactic from the ground-truth data and associating the second tactic with the second technology;
training a statistical model to predict threats to the first technology based on at least one of the first tactic and the second tactic in response to the first technology matching the second technology; and
predicting a likelihood of a compromise to the first technology using the statistical model.
